(19) United States
(12) Patent Application Publication
(10) Pub. No.: US 2025/0309802 A1
(43) Pub. Date: Oct. 2, 2025

(54) SEMICONDUCTOR DEVICE AND MOTOR CONTROL PROGRAM

(71) Applicant: Renesas Electronics Corporation, Tokyo (JP)

(72) Inventors: Takumi SANO, Tokyo (JP); Hiroyuki KOKUBUN, Tokyo (JP)

(21) Appl. No.: 19/066,255

(22) Filed: Feb. 28, 2025

(30) Foreign Application Priority Data
Apr. 1, 2024 (JP) 2024-059212

(51) Int. Cl. H02P 21/05; F25B 31/02; H02P 21/18; H02P 21/22; H02P 27/12

(52) U.S. Cl. CPC H02P 21/05; F25B 31/02; H02P 21/18; H02P 21/22; H02P 27/12

(57) ABSTRACT

A RAM stores a compensation value table in which a torque compensation value of each of discrete rotation angles that are discrete rotation angles of a motor is registered. A processor performs a step (a) of extracting a vibration component based on speed difference between a speed command value and a value of a rotation speed of the motor, and of calculating and deriving an update amount of each of the discrete rotation angles required for suppressing the vibration component. The processor further performs a step (b) of updating the compensation value table based on the update amount of each of the discrete rotation angles. The processor further performs a step (c) of calculating and deriving the torque compensation value of each any rotation angle of the motor by use of the compensation value table and a completion function, and of reflecting it to a motor control signal.

### CROSS-REFERENCE TO RELATED APPLICATION

The disclosure of Japanese Patent Application No. 2024-059212 filed on Apr. 1, 2024, including the specification, drawings and abstract is incorporated herein by reference in its entirety.

### BACKGROUND

The present invention relates to a semiconductor device and a motor control program.

There is disclosed technique listed below.
[Patent Document 1] Japanese Unexamined Patent Application Publication No. 2001-037287

The Patent Document 1 discloses a controller capable of suppressing vibration of a frequency proportional to a rotation speed of a motor. The controller detects vibration by using an acceleration sensor installed at a predetermined position, and extracts only a frequency component, whose vibration is to be suppressed, by using Fourier transformation. The controller generates a compensation signal for suppressing the vibration of the extracted frequency component by performing repetitive control using a repetitive compensator, and adds the generated compensation signal to a command value. To the contrary, basic compensation data for the compensation signal is created for each rotation speed. Consequently, a used memory capacity in the repetitive compensator increases. Thus, the controller of the motor creates compensation data for a new rotation speed by performing linear interpolation for data around the speed while using a plurality of items of the compensation data created for the plurality of rotation speeds.

### SUMMARY

For example, by the use of the system disclosed in the Patent Document 1, possible cyclic vibration, that is, torque vibration in the motor can be suppressed. However, the system in the Patent Document 1 has a risk of difficulty in reduction of the used memory capacity together with accurate suppression of the torque vibration. Specifically, the basic compensation data for the compensation signal can be defined by, for example, a compensation value table indicating a compensation value of each rotation angle of the motor. In order to reduce the used memory capacity based on the table, it is necessary to decrease the resolution of the rotation angle or the compensation value, or decrease the number of tables, that is, the number of frequency components to be suppressed. This results in a decrease in the accuracy in suppressing the torque vibration.

The following embodiments have been made in consideration of such circumstances, and other objects and novel characteristics will become apparent from the description of the present specification and the accompanying drawings.

A semiconductor device according to an embodiment is a device configured to output a motor control signal to an inverter supplying a power to a motor and configured to control the motor via the inverter, and includes: a memory configured to store a program; and a processor configured to execute the program stored in the memory. The memory further stores a compensation value table in which a compensation value of each of discrete rotation angles that are discrete rotation angles of the motor is registered. The processor performs a step (a) of extracting a vibration component based on a speed difference between a speed command value and a value of a rotation speed of the motor, and calculating an update amount of each of the discrete rotation angles required for suppressing the vibration component. The processor further performs a step (b) of updating the compensation value table, based on the update amount of each of the discrete rotation angles. The processor further performs a step (c) of calculating and deriving the compensation value of each any rotation angle of the motor by use of the compensation value table and a completion function, and reflecting the calculated and derived compensation value to the motor control signal.

According to the embodiment, a used memory capacity can be reduced while torque vibration can be accurately suppressed.

### BRIEF DESCRIPTIONS OF THE DRAWINGS

FIG. 1 is a schematic diagram illustrating an exemplary configuration of a motor system to which a semiconductor device according to a first embodiment is applied.

FIG. 2 is a block diagram illustrating a detailed exemplary configuration of the semiconductor device of FIG. 1.

FIG. 3 is a schematic diagram for explaining exemplary torque vibration.

FIG. 4 is a block diagram illustrating an exemplary configuration of a torque vibration compensator of FIG. 2 in the semiconductor device according to the first embodiment.

FIG. 5 is a schematic diagram illustrating exemplary schematic operations of a vibration component extractor and a compensation value table update circuit of FIG. 4.

FIG. 6 is a diagram for explaining exemplary operations of a completion-function generation circuit of FIG. 4.

FIG. 7 is a diagram for explaining a boundary-value expansion method for polynomial approximation performed by the completion-function generation circuit of FIG. 4.

FIG. 8 is a schematic diagram illustrating exemplary specific operations of a compensation-value completion circuit of FIG. 4.

FIG. 9A is a diagram illustrating exemplary results of verifying a vibration suppressive effect while applying a system according to the first embodiment of FIG. 4.

FIG. 9B is a diagram illustrating exemplary results of verifying the vibration suppressive effect while applying a system according to a comparative example of FIG. 17.

FIG. 10 is a schematic diagram for comparing torque compensation values in use of the systems according to the comparative example and the first embodiment.

FIG. 11 is a block diagram illustrating an exemplary schematic configuration of main components in a vibration component extractor of FIG. 4.

FIG. 12 is a block diagram illustrating an exemplary configuration of the torque vibration compensator of FIG. 2 in a semiconductor device according to a second embodiment.

FIG. 13A is a diagram illustrating an exemplary torque compensation value calculated and derived by use of a primary interpolation function in a completion-function calculation circuit of FIG. 12.

FIG. 13B is a diagram illustrating an exemplary torque compensation value calculated and derived by use of a secondary interpolation function in the completion-function calculation circuit of FIG. 12.

FIG. 14 is a schematic diagram illustrating exemplary specific operations of the compensation-value completion circuit of FIG. 12.

FIG. 15 is a diagram illustrating exemplary results of verifying the vibration suppressive effect while applying a system according to the second embodiment of FIG. 12.

FIG. 16 is a diagram illustrating exemplary results of comparing and verifying the vibration suppressive effect for the used memory capacity in the systems according to the first embodiment, the second embodiment, and the comparative example.

FIG. 17 is a block diagram illustrating an exemplary configuration of a torque vibration compensator according to the system of the comparative example.

FIG. 18 is a diagram illustrating exemplary torque compensation values generated by the torque vibration compensator of FIG. 17.

FIG. 19 is a schematic diagram illustrating exemplary specific operations of a compensation-value table read circuit of FIG. 17.

### DETAILED DESCRIPTION

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specified number is also applicable.

Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Hereinafter, embodiments of the present invention will be described in detail with reference to the accompanying drawings. Note that the same components are denoted by the same reference symbols throughout all the drawings for describing the embodiments, and the repetitive description thereof will be omitted.

### First Embodiment

### <Outline of Semiconductor Device>

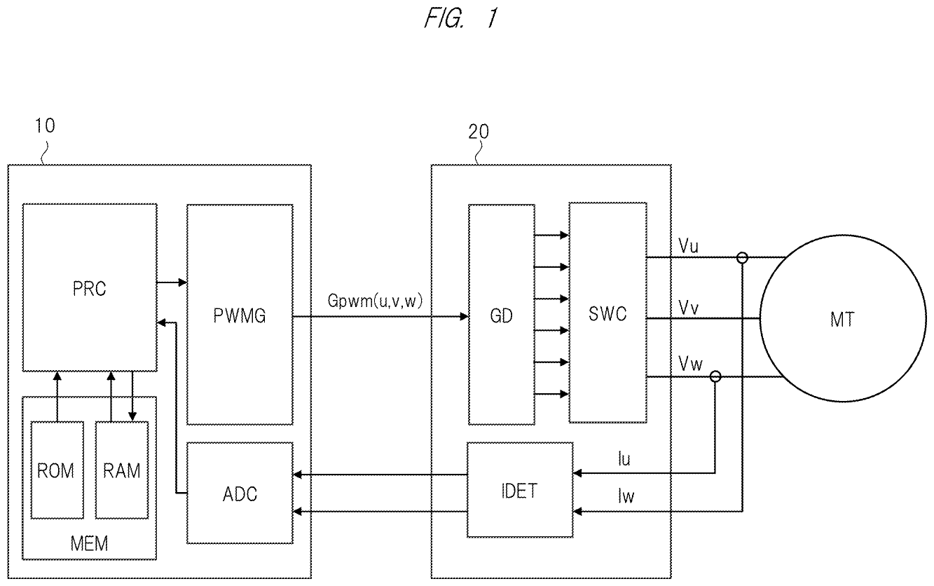

FIG. 1 is a schematic diagram illustrating an exemplary configuration of a motor system to which a semiconductor device according to a first embodiment is applied. The motor system of FIG. 1 includes a semiconductor device 10, an inverter 20, and a motor MT. The motor MT is, for example, a three-phase motor made of U phase, V phase, and W phase. The semiconductor device 10 generates and outputs a motor control signal for controlling the motor MT such as a pulse width modulation (PWM) signal Gpwm. The inverter 20 supplies an alternate-current power based on the motor control signal to each phase of the motor MT.

The semiconductor device 10 is, for example, a microcontroller or a system on chip (SoC) made of one semiconductor chip. The semiconductor device 10 mainly includes a processor PRC, a memory MEM, a PWM signal generator PWMG, and an analog-digital converter ADC. The processor PRC is, for example, a central processing unit (CPU) or a digital signal processor (DSP). The memory MEM includes a read only memory (ROM) and a random access memory (RAM). The ROM is, for example, a flash memory. The RAM is, for example, an SRAM or a DRAM.

The ROM stores a motor control program therein. The motor control program is copied into the RAM. The processor PRC controls the motor MT by executing the motor control program copied into the RAM. The PWM signal generator PWMG generates, for example, a PWM signal Gpwm (u, v, w) for each phase, based on a duty-ratio command value for each phase from the processor PRC. The analog-digital converter ADCA receives, its input, a detection signal indicating a state of the motor MT, that is, a detection signal indicting phase current of the motor MT in this example, via the inverter 20. The analog-digital converter ADC converts the detection signal into a digital value.

The inverter 20 includes a gate driver GD, a switching circuit SWC, and a current detector IDET. The switching circuit SWC is made of, for example, a three-phase bridge circuit including six switching elements. The gate driver GD receives, as its input, the PWM signal Gpwm (u, v, w) for each phase from the semiconductor device 10, and controls the six switching elements in the switching circuit SWC to be turned ON/OFF in response to the PWM signal Gpwm (u, v, w). Thereby, the switching circuit SWC supplies phase voltages Vu, Vv, and Vw of the three phases depending on the duty ratio of the PWM signal, to the motor MT.

The current detector IDET detects phase currents Iu and Iw flowing through at least two phases of the motor MT, that are the U phase and the W phase in this example. The analog-digital converter ADC in the semiconductor device 10 converts the phase currents Iu and Iw detected by the current detector IDET into digital values. Note that the phase current Iv flowing through the remaining phase can be derived from a relationship of “Iu+Iv+Iw=0.” The phase currents Iu, Iv, and Iw may be derived from the ON/OFF states of the six switching elements in a current detection circuit system in which the phase currents Iu, Iv, and Iw of the three phases are collectively detected by single current detector.

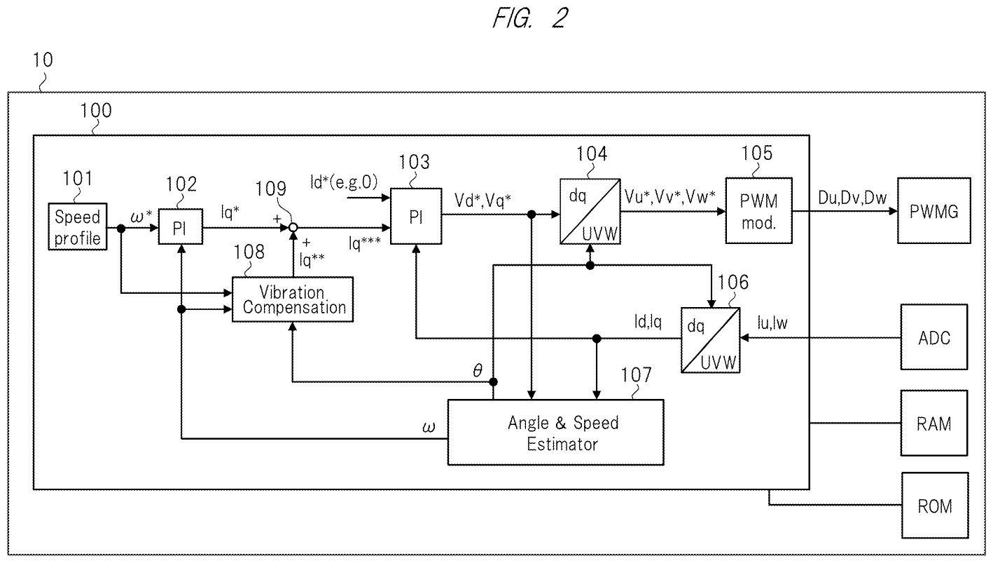

FIG. 2 is a block diagram illustrating a detailed exemplary configuration of the semiconductor device of FIG. 1. The semiconductor device 10 of FIG. 2 includes a motor controller 100 in addition to the PWM signal generator PWMG, the analog-digital converter ADC, the RAM, and the ROM which are illustrated in FIG. 1. The motor controller 100 is achieved by the processor PRC of FIG. 1 executing the motor control program stored in the RAM. In other words, by the motor control program, the processor PRC is functioned as each component in the motor controller 100 of FIG. 2.

The motor controller 100 includes a speed commander 101, a speed controller 102, a current controller 103, a two-phase/three-phase converter 104, a PWM signal modulator 105, a three-phase/two-phase converter 106, a rotation-angle/speed estimator 107, a torque vibration compensator 108, and an adder 109.

The three-phase/two-phase converter 106 receives, as its input, the phase currents Iu and Iw of the two phases from the analog-digital converter ADC and a rotation angle θ from the rotation-angle/speed estimator 107. Then, the three-phase/two-phase converter 106 converts the phase currents Iu, Iv, and Iw of the three phases with UVW coordinates obtained by the phase currents Iu and Iw of the two phases into a d-axis current Id and a q-axis current Iq with dq coordinates by using Clarke conversion and Park conversion using the rotation angle θ. The UVW coordinates are rotating coordinates. The dq coordinates are fixed coordinates.

The speed commander 101 generates a speed command value ω* based on, for example, a preset speed profile. The speed controller 102 performs, for example, proportional-integral (PI) control or the like based on a speed difference between the speed command value ω* and a value of a rotation speed ω from the rotation-angle/speed estimator 107. Thereby, the speed controller 102 generates a q-axis current command value Iq* for making the speed difference closer to zero.

The adder 109 adds the q-axis current command value Iq* from the speed controller 102 and a q-axis current command value Iq** from the torque vibration compensator 108, and outputs an addition result as a q-axis current command value Iq***. Although described in detail later, the torque vibration compensator 108 generates, for example, a torque compensation value for suppressing the torque vibration as the q-axis current command value Iq** for vibration suppression, based on the speed difference between the speed command value ω* and the value of the rotation speed ω from the rotation-angle/speed estimator 107.

The current controller 103 receives, as its input, the q-axis current command value Iq*** from the adder 109 and a d-axis current command value Id*. The d-axis current command value Id* is fixed to, for example, zero. Note that the d-axis current command value Id* may be generated based on flux weakening control or “maximum torque per ampere” control. The current controller 103 performs PI control or the like based on a current difference between the q-axis current command value Iq* as well as the d-axis current command value Id* and the value of the q-axis current Iq as well as the value of the d-axis current Id from the three-phase/two-phase converter 106. Thereby, the current controller 103 generates a d-axis voltage command value Vd* and a q-axis voltage command value Vq* for making the current difference closer to zero.

The two-phase/three-phase converter 104 receives, as its input, the d-axis voltage command value Vd* and the q-axis voltage command value Vq* from the current controller 103 and the rotation angle θ from the rotation-angle/speed estimator 107. At this time, a rotation angle θ corrected in consideration of the rotation of the motor MT may be used. The two-phase/three-phase converter 104 converts the d-axis voltage command value Vd* and the q-axis voltage command value Vq* with the dq coordinates into the voltage command values Vu*, Vv*, and Vw* of the three phases with the UVW coordinates by using inverse Park transformation and inverse Clarke transformation using the rotation angle θ. The PWM signal modulator 105 converts the voltage command values Vu*, Vv*, and Vw* of the three phases into duty-ratio command values Du, Dv, and Dw of the three phases, respectively, and then, outputs the duty-ratio command values Du, Dv, and Dw to the PWM signal generator PWMG.

The rotation-angle/speed estimator 107 receives, as its input, the respective values of the d-axis current Id and the q-axis current Iq from the three-phase/two-phase converter 106, and the d-axis voltage command value Vd* and the q-axis voltage command value Vq* from the current controller 103. The rotation-angle/speed estimator 107 calculates and derives d-axis and q-axis inductive voltages based on the input values and a preset motor-state equation. The rotation-angle/speed estimator 107 then calculates and derives, in other words, estimates or detects the rotation angle θ based on the calculated and derived d-axis and q-axis inductive voltages. The rotation-angle/speed estimator 107 further calculates and derives the rotation speed ω by differentiating the rotation angle θ. However, the rotation-angle/speed estimator 107 may calculate and derive magnetic fluxes instead of the inductive voltages, thereby calculating the rotation angle θ.

Note that FIG. 2 illustrates the motor controller 100 for performing sensorless vector control. However, the motor controller 100 may perform vector control with a sensor. In this case, a position/speed sensor is installed in the motor MT instead of the rotation-angle/speed estimator 107. The position/speed sensor is, for example, a rotary encoder or the like for detecting the rotation angle θ and the rotation speed ω. In this example, the motor controller 100 is achieved by a program processing using the processor PRC. However, the motor controller 100 may be achieved by use of not the processor PRC but, for example, a field programmable gate array (FPGA). That is, the semiconductor device 10 of FIG. 1 may be the FPGA or the like.

### <Torque Vibration>

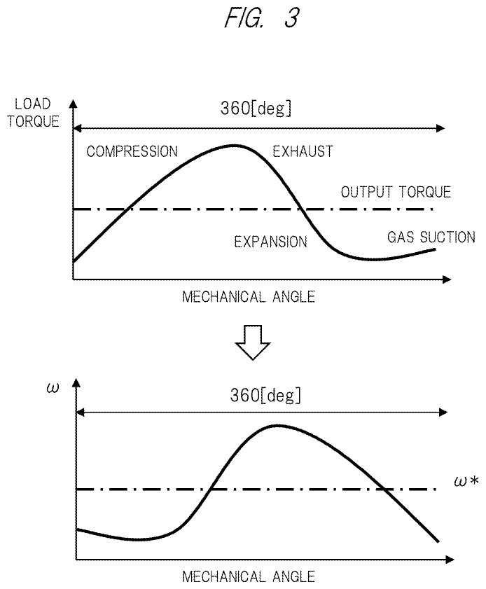

FIG. 3 is a schematic diagram for explaining exemplary torque vibration. For example, in FIGS. 1 and 2, when a torque is added as disturbance to the motor MT, the rotation speed ω of the motor MT vibrates. Such vibration is called torque vibration. In a specific example, as illustrated in FIG. 3, a compressor motor mounted on an air conditioner sequentially compresses and expands a refrigerant during rotation of the motor MT, more specifically a rotor, at a mechanical angle of 360 [deg]. Accordingly, load torque fluctuates. The torque vibration may be caused by a difference between the load torque and the output torque.

The torque vibration is cyclically caused depending on the rotation angle as the mechanical angle of the motor MT, in other words, the magnetic pole position, thereby fluctuating the rotation speed ω of the motor MT. A frequency of the torque vibration synchronizes with the rotation speed ω of the motor MT. Thus, low-frequency torque vibration is caused at a low speed. The low-frequency torque vibration particularly causes occurrence of noises, reduction in life of the motor system, and the like. Thus, it is desirable to suppress the torque vibration.

### <Details of Torque Vibration Compensator>

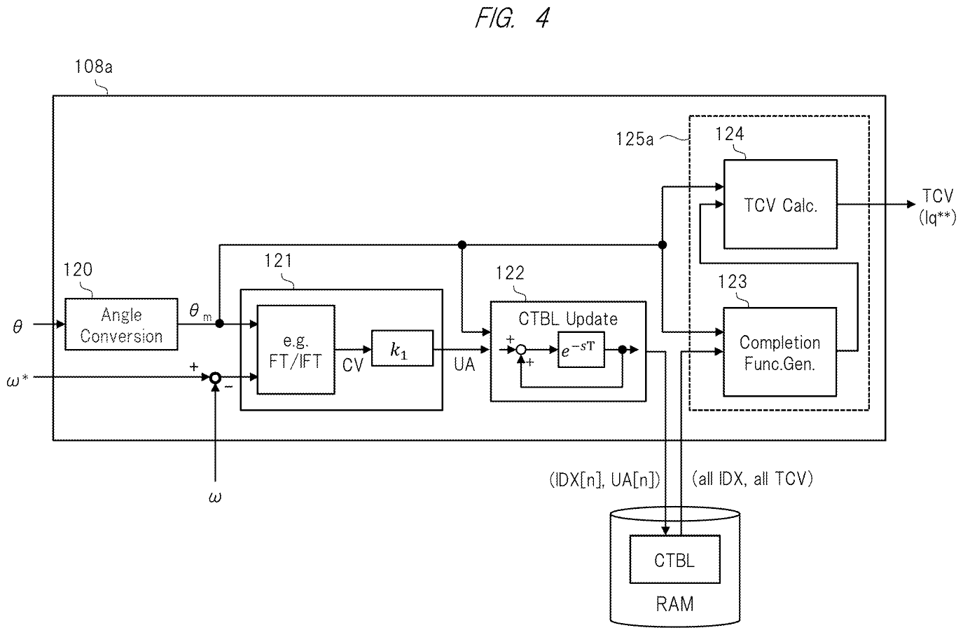

FIG. 4 is a block diagram illustrating an exemplary configuration of the torque vibration compensator 108 of FIG. 2 in the semiconductor device according to the first embodiment. A torque vibration compensator 108a of FIG. 4 includes a rotation angle converter 120, a vibration component extractor 121, a compensation-value table update circuit 122, completion-function generation circuit 123, and a compensation-value calculation circuit 124. The completion-function generation circuit 123 and the compensation-value calculation circuit 124 configure a compensation-value completion circuit 125a. In the torque vibration compensator 108a, a compensation-value table CTBL is stored in the memory MEM, more specifically the RAM.

The rotation angle converter 120 converts the rotation angle θ as an electrical angle from the rotation-angle/speed estimator 107 of FIG. 2 into a rotation angle θm as a mechanical angle based on the number of poles of the motor MT. In this example, the vibration component extractor 121 extracts a torque vibration component based on the speed difference between the speed command value ω* from the speed commander 101 of FIG. 2 and the value of the rotation speed ω from the rotation-angle/speed estimator 107. Then, the vibration component extractor 121 calculates and derives an update amount UA of the torque compensation value of each rotation angle θm, required for suppressing the extracted torque vibration component.

Specifically, the vibration component extractor 121 may be made of, for example, a Fourier transformer FT, an inverse Fourier transformer IFT, and a multiplier for multiplying a compensation value gain k₁. The Fourier transformer FT performs Fourier transformation on the speed difference obtained when receiving the values of the speed command value ω* and the rotation speed ω as positive input and negative input, respectively. Thereby, the Fourier transformer FT can calculate and derive frequency domain data such as amplitude, frequency, and phase of a cancel component for canceling the remaining torque vibration component.

Note that the Fourier transformer FT may perform Fourier transformation on not such a speed difference but, for example, a detection signal output an from acceleration sensor or the like preinstalled in the motor MT or the like. In this case, however, the acceleration sensor or the like is required. Thus, it is desirable to use the speed difference in terms of a reduction in cost or in terms of efficiency due to the use of the existing speed command value ω* and rotation speed ω.

The inverse Fourier transformer IFT performs inverse Fourier transformation on the frequency domain data of the cancel component obtained by the Fourier transformer FT, thereby generating time domain data of the cancel component. The inverse Fourier transformer IFT then makes the time domain data of the cancel component discrete for each rotation angle θm at a predetermined interval, thereby generating a cancel value CV of each rotation angle θm as a discrete value. The vibration component extractor 121 multiplies the cancel value CV by the compensation value gain k₁, thereby generating the update amount UA of each rotation angle θm as the discrete value.

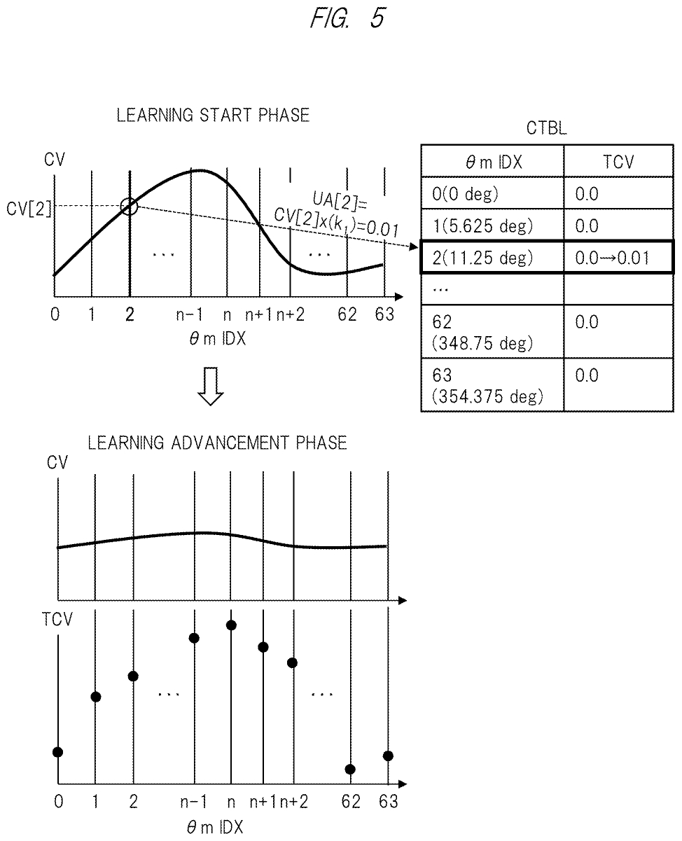

The compensation-value table update circuit 122 is made of, for example, an integrator. For each rotation angle θm, the compensation-value table update circuit 122 integrates the update amount UA of each rotation angle θm output from the vibration component extractor 121, thereby calculating a torque compensation value TCV of each rotation angle θm. Specifically, the compensation-value table update circuit 122 performs such integration by use of the compensation value table CTBL as illustrated in FIG. 5.

FIG. 5 is a schematic diagram illustrating exemplary schematic operations of the vibration component extractor 121 and the compensation-value table update circuit 122 of FIG. 4. In FIG. 5, the rotation angle θm as the discrete value, in other words, the torque compensation value TCV of each mechanical angle as the discrete value, is registered in the compensation value table CTBL. In the present specification, the discrete rotation angles of the motor MT, which are registered in the compensation value table CTBL, are also called discrete rotation angles θm. In this example, the discrete rotation angles θm are expressed by 64 indexes IDX[0], IDX[1], . . . , IDX[63] corresponding to one rotation. In this case, the rotation angle θm between adjacent indexes IDX, in other words, the resolution is 5.625 (=360/64) [deg].

Thereby, for example, the discrete rotation angles θm corresponding to the first index IDX[0] and the last index IDX are 0 [deg] and 354.375 [deg], respectively. In this case, due to repeated control at a mechanical angle cycle of 360 [deg], a next index IDX of the last index IDX returns to the first index IDX[0]. The compensation-value table update circuit 122 updates the compensation value table CTBL, based on the update amount UA from the vibration component extractor 121. Thereby, the compensation value table CTBL is updated by learning.

Specifically, the vibration component extractor 121 outputs the update amount UA for, for example, each time when the rotation angle θm of the motor MT reaches the discrete rotation angle θm. In a specific example, it is assumed that the rotation angle θm reaches the discrete rotation angle θm that is 11.25 [deg] corresponding to the index IDX[2], in the initial learning phase of FIG. 5. In this case, the vibration component extractor 121 multiplies the cancel value CV [2] at 11.25 [deg] based on the inverse Fourier transformer IFT by the compensation value gain k₁, thereby outputting “0.01” as the update amount UA [2].

Accordingly, the compensation-value table update circuit 122 adds “0.01” as the update amount UA [2] to “0.0” as the current torque compensation value TCV at the index IDX[2] in the compensation value table CTBL. A processing similar to that at the index IDX[2] is performed also at the subsequent indexes IDX[3], [4], . . . . In this way, for each discrete rotation angle θm that is each index IDX, the compensation-value table update circuit 122 integrates the update amount UA of each discrete rotation angle θm, thereby updating the compensation value table CTBL.

Although described in detail later, the q-axis current command value Iq** of FIG. 2 described here is defined based on the torque compensation value TCV registered in the compensation value table CTBL. Consequently, the torque compensation value TCV is reflected on the PWM signal Gpwm as a motor control signal. The update amount UA or the cancel value CV from the vibration component extractor 121 substantially indicates a value for suppressing or canceling the still-remaining torque vibration component when a current torque compensation value TCV is applied. Thus, as illustrated in FIG. 5, the cancel value CV decreases for each advancement of the learning of the compensation value table CTBL, accordingly each advancement of the suppression of the torque vibration component. Accordingly, the torque compensation value TCV registered in the compensation value table CTBL converges to a predetermined value.

### «System According to Comparative Example>

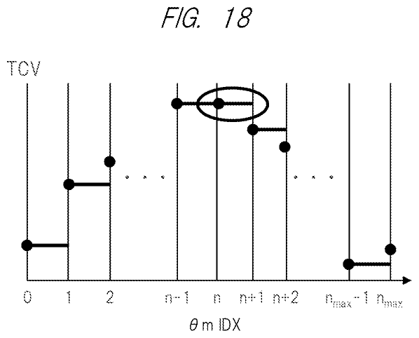

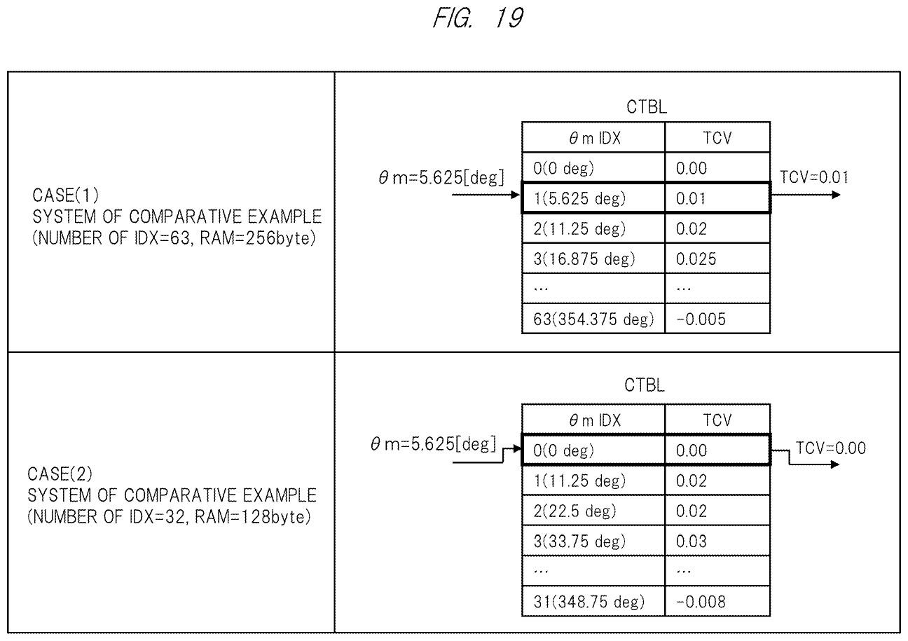

FIG. 17 is a block diagram illustrating an exemplary configuration of a torque vibration compensator 108c in a system according to a comparative example. FIG. 18 is a diagram illustrating an exemplary torque compensation value TCV generated by the torque vibration compensator 108c of FIG. 17. FIG. 19 is a schematic diagram illustrating exemplary specific operations of a compensation-value table read circuit 130 of FIG. 17. The torque vibration compensator 108c of FIG. 17 includes the compensation-value table read circuit 130 instead of the compensation-value completion circuit 125a of FIG. 4.

The compensation-value table read circuit 130 reads a corresponding torque compensation value TCV as the q-axis current command value Iq** of FIG. 2 with reference to the compensation value table CTBL, based on the rotation angle θm from the rotation angle converter 120. Specifically, when, for example, receiving, as its input, the rotation angle θm between adjacent indexes IDX as illustrated in FIG. 18, the compensation-value table read circuit 130 outputs the torque compensation value TCV of the immediately precedent index IDX. That is, when receiving, as its input, the rotation angle θm between the precedent index IDX[n] and the subsequent index IDX[n+1], the compensation-value table read circuit 130 outputs the torque compensation value TCV of the precedent index IDX[n].

In a specific example, in case (1) of FIG. 19, the compensation value table CTBL includes 64 indexes IDX. Accordingly, the resolution of the discrete rotation angle θm is 5.625 [deg]. For example, when the torque compensation value TCV is expressed as a “float” digital value that is four bytes, the required memory capacity is 256 bytes (=4 bytes×64). When receiving, as its input, the rotation angle θm of 5.625 [deg] from the rotation angle converter 120, based on the compensation value table CTBL, the compensation-value table read circuit 130 outputs “0.01” as the torque compensation value TCV of the index IDX[1].

To the contrary, in case (2), the compensation value table CTBL includes 32 indexes IDX. Accordingly, the resolution of the discrete rotation angle θm is 11.25 [deg]. The required memory capacity is 128 bytes (=4 bytes×32). When receiving, as its input, the rotation angle θm of 5.625 [deg] from the rotation angle converter 120, based on the compensation value table CTBL, the compensation-value table read circuit 130 outputs “0.00” as the torque compensation value TCV of the index IDX[0]. Note that “0.01” is essentially desirable as the torque compensation value.

For example, under the use of the configuration of FIG. 17, the torque compensation value TCV of each discrete rotation angle θm is reflected on the q-axis current command value Iq**, accordingly on the motor control signal, thereby suppressing the torque vibration caused by the cyclic disturbance as illustrated in FIG. 3. However, as can be seen from FIG. 19, the configuration of FIG. 17 may be difficult to reduce the used memory capacity while accurately suppressing the torque vibration.

In specifical explanation, the number of the compensation value tables CTBL is not limited to one but may be specifically the number of the frequency components for which the torque vibration is to be suppressed. In each compensation value table CTBL, digital values indicating the torque compensation values TCV are required as many as the indexes IDX corresponding to the discrete rotation angles θm. Thereby, the used memory capacity that is the used RAM capacity is defined by an item (a) that is the number of compensation value tables CTBL, an item (b) that is the resolution of the digital value indicating each torque compensation value TCV, in other words, data type, and an item (c) that is the number of indexes IDX.

In order to accurately suppress the torque vibration, at least any of the items (a), (b), and (c) is to be increased. Among them, it is particularly beneficial to increase the item (c) that is the number of indexes IDX in order to decrease steps in step-like properties of FIG. 18. However, for example, if the memory capacity itself mounted on the semiconductor device 10 is limited, it is not easy to increase the item (c), and not easy to increase the items (a) and (b), either.

### «System According to Embodiment»

### [Details of Compensation-Value Completion Circuit]

Accordingly, the torque vibration compensator 108a of FIG. 4 includes the compensation-value completion circuit 125a which is made of the completion-function generation circuit 123 and the compensation-value calculation circuit 124. Schematically, the compensation-value completion circuit 125a calculates and derives the torque compensation value TCV of each any rotation angle θm of the motor MT by use of the compensation value table CTBL and the completion function. Then, the compensation-value completion circuit 125a reflects the calculated and derived torque compensation value TCV to the motor control signal such as the PWM signal Gpwm.

Specifically, the completion-function generation circuit 123 performs polynomial approximation when receiving, as its input, the torque compensation value TCV of each discrete rotation angle θm registered in the compensation value table CTBL. Thereby, as the completion function, the completion-function generation circuit 123 generates a polynomial indicating a relationship between the discrete rotation angle θm and the torque compensation value TCV. The compensation-value calculation circuit 124 calculates and derives the torque compensation value TCV of each any rotation angle θm from the rotation angle converter 120, based on the polynomial generated the completion function in generation circuit 123. Thereby, the torque compensation value TCV is an approximate value calculated and derived by use of the completion function.

Specifically, the polynomial, which is obtained by performing the polynomial approximation on the compensation value table CTBL, is expressed by Equation (1) using a matrix A obtained from a rotation angle “i,” a polynomial coefficient “x,” and “y” indicating the torque compensation value TCV. For example, if a quartic polynomial is used, the polynomial is expressed by Equation (2). In this case, the “y” indicating the torque compensation value TCV is expressed by Equation (3).

$$\begin{matrix}[ Equation 1 ] & \\ Ax = y & ( 1 )\end{matrix}$$

$$\begin{matrix}[ Equation 2 ] & \\ [ \begin{matrix}1 & {i}_{0} & {i}_{0}^{2} & {i}_{0}^{3} & {i}_{0}^{4} \\ 1 & {i}_{1} & {i}_{1}^{2} & {i}_{1}^{3} & {i}_{1}^{4} \\ 1 & {i}_{2} & {i}_{2}^{2} & {i}_{2}^{3} & {i}_{2}^{4} \\ 1 & {i}_{3} & {i}_{3}^{2} & {i}_{3}^{3} & {i}_{3}^{4} \\ 1 & {i}_{4} & {i}_{4}^{2} & {i}_{4}^{3} & {i}_{4}^{4}\end{matrix} ] [ \begin{matrix}e \\ d \\ c \\ b \\ a\end{matrix} ] = [ \begin{matrix}{y}_{0} \\ {y}_{1} \\ {y}_{2} \\ {y}_{3} \\ {y}_{4}\end{matrix} ] & ( 2 )\end{matrix}$$

$$\begin{matrix}[ Equation 3 ] & \\ \hat{y} = {ai}^{4} + {bi}^{3} + {ci}^{2} + di + e & ( 3 )\end{matrix}$$

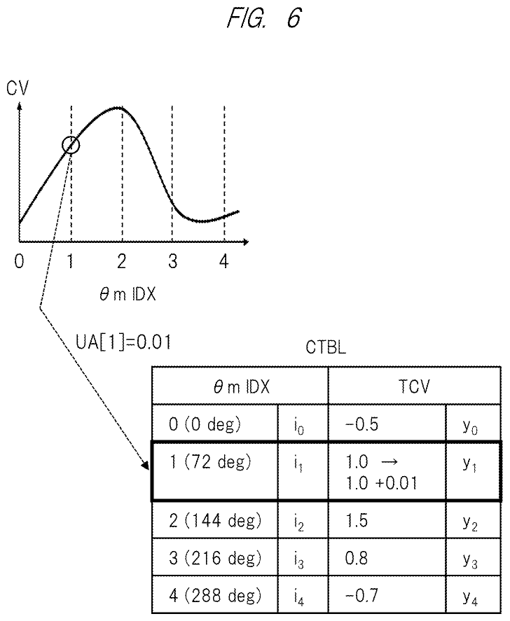

FIG. 6 is a diagram for explaining exemplary operations of the completion-function generation circuit 123 of FIG. 4. As similar to FIG. 5, FIG. 6 illustrates a state of update of the torque compensation value TCV[1] of the index IDX[1] in the compensation value table CTBL from “1.0” to “1.01” based on the update amount UA [1]. However, the compensation value table CTBL includes five indexes that are “k+1” indexes IDX[0] to IDX[4] in accordance with the quartic polynomial that is a k-order polynomial. In this case, the resolution of the discrete rotation angle θm is 72 [deg].

In Equation (2), the values of i₀, i₁, . . . , i₄ configuring the matrix A are 0, 72, . . . , 288 [deg] as the discrete rotation angles θm, respectively, as illustrated in FIG. 6. The values of i₀, i₁, . . . , i₄ may be 0, 1, . . . , 4 as the values of the indexes IDX, respectively. That is, the value of an index IDX is a normalized value of the discrete rotation angle θm. Thus, either the value of the discrete rotation angle θm or the value of the index IDX may be used. And, in the example of FIG. 6, values of y₀, y₁, . . . , y₄ indicating the torque compensation values TCV are −0.5, 1.01, . . . , −0.7, respectively.

The completion-function generation circuit 123 performs the polynomial approximation for each time when the rotation angle θm of the motor MT reaches the discrete rotation angle θm to update the compensation value table CTBL as illustrated in FIG. 6. Specifically, the completion-function generation circuit 123 calculates, derives and updates the polynomial coefficients x=(a, b, c, d, e) in Equation (2) and Equation (3). The polynomial coefficients x=(a, b, c, d, e) can be calculated and derived by Equation (4) using an inverse matrix A⁻¹.

$$\begin{matrix}[ Equation 4 ] & \\ x = {A}^{- 1} y & ( 4 )\end{matrix}$$

In Equation (4), a value of the inverse matrix A⁻¹ is known. The value of “y” as the torque compensation value TCV is a sequentially-updated value. Thus, for example, in the case of the quartic polynomial, the completion-function generation circuit 123 solves five simultaneous linear equations each including five polynomial coefficients x=(a, b, c, d, e), thereby calculating the five polynomial coefficients x=(a, b, c, d, e). At this time, the completion-function generation circuit 123 may calculate and derive the five polynomial coefficients x=(a, b, c, d, e) by use of a well-known method of solving the simultaneous linear equations.

For example, a direct method and an indirect method are known as the method of solving the simultaneous linear equations. The Gauss elimination method, the LU decomposition, and the like are known as the direct methods. The Gauss-Seidel method, the Jacobi method, the conjugate gradient method, and the like are known as the indirect methods. For example, the LU decomposition is a calculation method of decomposing a square matrix A into a product of a matrix “L” and a matrix U”.” The matrix “L” is a lower triangular matrix or a left triangular matrix. The matrix “U” is an upper triangular matrix or a right triangular matrix.

As illustrated in FIG. 5, the torque compensation value TCV is updated by learning, and converges to a predetermined value along with advancement of the learning, that is, along with advancement of the suppression of the torque vibration. Accordingly, the values of the polynomial coefficients x=(a, b, c, d, e) are also updated by indirect learning, and converge to a predetermined value along with the advancement of the learning. The compensation-value calculation circuit 124 receives, as its input, any rotation angle θm from the rotation angle converter 120, and calculates and derives the torque compensation value TCV of this rotation angle θm based on the quartic polynomial generated in the completion-function generation circuit 123. Then, the compensation-value calculation circuit 124 outputs the calculated and derived torque compensation value TCV as the q-axis current command value Iq** of FIG. 2.

### [Boundary-Value Expansion Method for Polynomial Approximation]

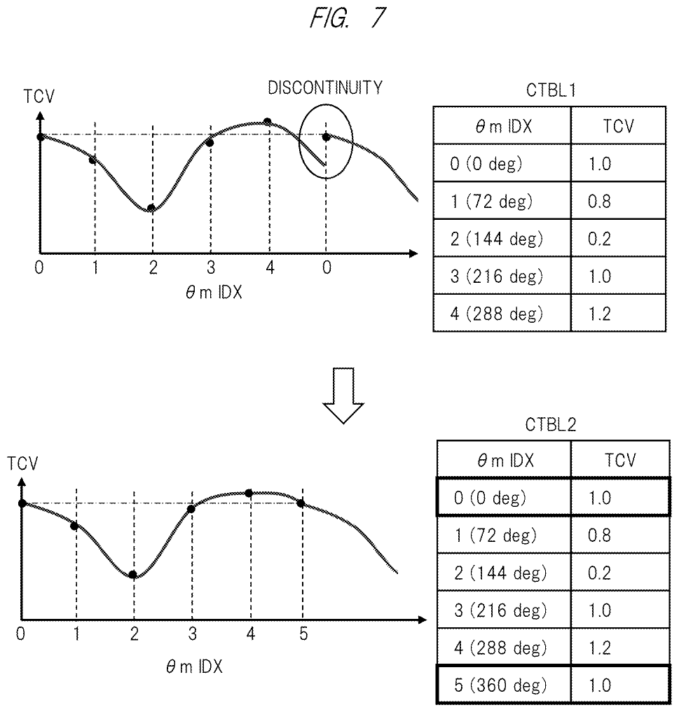

FIG. 7 is a diagram for explaining the boundary-value expansion method for the polynomial approximation performed by the completion-function generation circuit 123 of FIG. 4. For example, assumed that a compensation value table CTBL1 including five indexes IDX[0] to IDX[4] with a resolution of 72 [deg] in which the last index IDX[4] is 288 [deg] is used as illustrated in an upper part of FIG. 7. In this case, the completion-function generation circuit 123 solves five simultaneous linear equations for the five indexes IDX, thereby generating a quartic polynomial based on the compensation value table CTBL1.

In this case, however, the torque compensation value TCV obtained by substituting the rotation angle θm of 360 [deg] into the quartic polynomial may be different from the torque compensation value TCV obtained by substituting the rotation angle θm of 0 [deg] into the quartic polynomial. That is, discontinuity may be caused in the torque compensation value TCV at the rotation angle θm of 0 [deg] (=360 [deg]). In this case, a large change may be caused based on the polynomial between the torque compensation value TCV output at the rotation angle θm of 359 [deg] and the torque compensation value TCV output when the rotation angle θm returns to 0 [deg] immediately after the rotation angle θm of 359 [deg]. The change may be a factor preventing the torque vibration suppressive effect.

Thus, as illustrated in a lower part of FIG. 7, the completion-function generation circuit 123 adds the index IDX[5] corresponding to the discrete rotation angle θm of 360 [deg] to a compensation value table CTBL2 while keeping the resolution of the compensation value table CTBL1. Then, the completion-function generation circuit 123 defines the torque compensation value TCV of 360 [deg] as the same value as the torque compensation value TCV of 0 [deg]. That is, when updating the torque compensation value TCV of 0 [deg], the completion-function generation circuit 123 also updates the torque compensation value TCV of 360 [deg] to the same value as that of 0 [deg].

The completion-function generation circuit 123 then performs the polynomial approximation on the compensation value table CTBL2 expanded as described above. That is, in this example, the completion-function generation circuit 123 solves six simultaneous linear equations, thereby generating a quintic polynomial. Consequently, as illustrated in FIG. 7, the discontinuity at the rotation angle θm of 0 [deg] (=360 [deg]) is not caused. Thereby, the torque vibration suppressive effect can be enhanced. As a verification result example, the vibration suppressive effect without the boundary-value expansion is about 96.9% while the vibration suppressive effect with the boundary-value expansion is about 98.2%.

### [Exemplary Specific Operations of Compensation-Value Completion Circuit]

FIG. 8 is a schematic diagram illustrating exemplary specific operations of the compensation-value completion circuit 125a of FIG. 4. In FIG. 8, the compensation value table CTBL includes six indexes IDX by use of the boundary-value expansion method. Accordingly, the resolution of the discrete rotation angle θm is 72 [deg]. As similar to FIG. 19, when the torque compensation value TCV is expressed as a 4-byte digital value, the used memory capacity to be required is 24 bytes (=4 bytes×6).

The completion-function generation circuit 123 performs the polynomial approximation on such a compensation value table CTBL. Thereby, the completion-function generation circuit 123 calculates and derives six polynomial coefficients x=(a, b, c, d, e, f), thereby generating a quintic polynomial y(i) including the six polynomial coefficients x. In this example, the rotation angle θm of 5.625 [deg] is input from the rotation angle converter 120. In this case, the completion-function generation circuit 123 performs the polynomial approximation on the compensation value table CTBL updated at the index IDX[0].

The compensation-value calculation circuit 124 receives, as its input, the rotation angle θm of 5.625 [deg], and substitutes 5.625 [deg] into the variable “i” of the quintic polynomial y(i) generated by the completion-function generation circuit 123. Thereby, the compensation-value calculation circuit 124 calculates and derives “0.01” as the torque compensation value TCV (=y(5.625)) of 5.625 [deg]. Note that this example uses the rotation angle θm as the variable “i”. However, the value of the index IDX may be used as described above. In this case, “5.625/72” may be substituted as the variable “i.”

### <Forward Compensation>

For simple explanation in FIG. 8 and others, the compensation-value calculation circuit 124 receives the rotation angle θm as its input, and calculates and outputs the torque compensation value TCV of the input rotation angle θm. However, more desirably, control delay is to be considered in order to accurately reflect the torque compensation value TCV defined by the compensation value table CTBL to the control for the motor MT.

For example, it is assumed that the compensation-value calculation circuit 124 receives a rotation angle θm[t] as its input at a certain point [t], and outputs a torque compensation value TCV[t] of the input rotation angle θm[t]. In this case, at a moment of the reflection of the torque compensation value TCV[t] to the motor MT, the actual rotation angle θm of the motor MT is a forward angle relative to the rotation angle θm[t]. Thus, in order to compensate for the control delay, the compensation-value calculation circuit 124 desirably performs forward compensation. In a specific example, when receiving a rotation angle θm such as 5 [deg] as its input, the compensation-value calculation circuit 124 calculates and outputs a torque compensation value TCV of a rotation angle θm such as 10 [deg] that is a forward angle by a predetermined angle relative to this input rotation angle θm.

### <Verification Results>

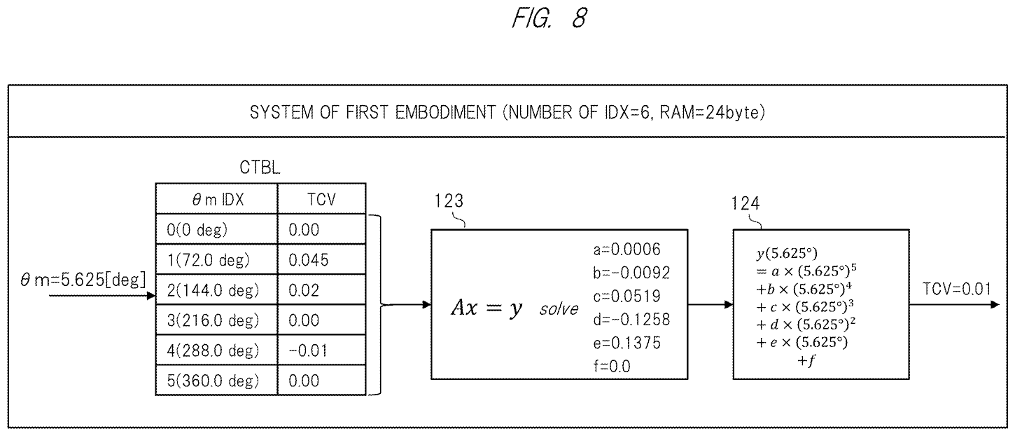

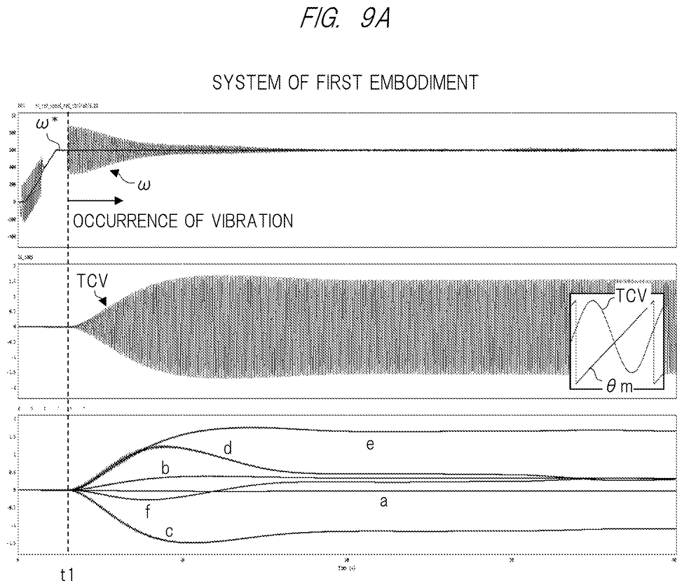

FIG. 9A is a diagram illustrating exemplary results of verifying the vibration suppressive effect in the application of the system according to the first embodiment of FIG. 4. FIG. 9B is a diagram illustrating exemplary results of verifying the vibration suppressive effect in the application of the system according to the comparative example of FIG. 17. FIGS. 9A and 9B illustrate time-series transitions of the speed command value ω*, the actual rotation speed ω of the motor MT, and the toque compensation value TCV. FIG. 9A also illustrates time-series transitions of the six polynomial coefficients (a to f).

Here, in both FIGS. 9A and 9B, the number of indexes IDX in the compensation value table CTBL is six. That is, the used memory capacity is the same between FIGS. 9A and 9B. Specifically, in FIG. 9A, the compensation value table CTBL2 as illustrated in the lower part of FIG. 7 is used. To the contrary, in FIG. 9B, the compensation value table CTBL in which the resolution of the discrete rotation angle θm is 60 [deg] (=360 [deg]/6) is used. And, in FIGS. 9A and 9B, a torque vibration component due to disturbance, in other words, a vibration component synchronized with the rotation speed ω is applied at time t1, and its suppressive effect is verified.

First, in the system according to the comparative example of FIG. 9B, a vibration suppressive effect of about 75.1% is obtained in comparison between a magnitude of the vibration component obtained when the torque vibration suppression converges and a magnitude of the vibration component obtained at the same time in a case without the torque vibration suppression. However, an amplitude of the torque compensation value TCV largely varies. That is, the torque compensation value TCV has excessively-large/small points. Note that the case without the torque vibration suppression is a case without the torque vibration compensator 108 of FIG. 2.

To the contrary, in the system according to the first embodiment of FIG. 9A, a vibration suppressive effect of about 98.2% is obtained in comparison between the magnitude of the vibration component obtained when the torque vibration suppression converges and the magnitude of the vibration component obtained at the same time in the case without the torque vibration suppression. That is, the used memory capacity can be further reduced while the torque vibration can be further accurately suppressed than the in system according to the comparative example. The amplitude of the torque compensation value TCV is almost constant. That is, the system provides the torque compensation value TCV that is neither excessively large nor excessively small but appropriate. The polynomial coefficients (a to f) converge to a predetermined value along with the advancement of the torque vibration suppression.

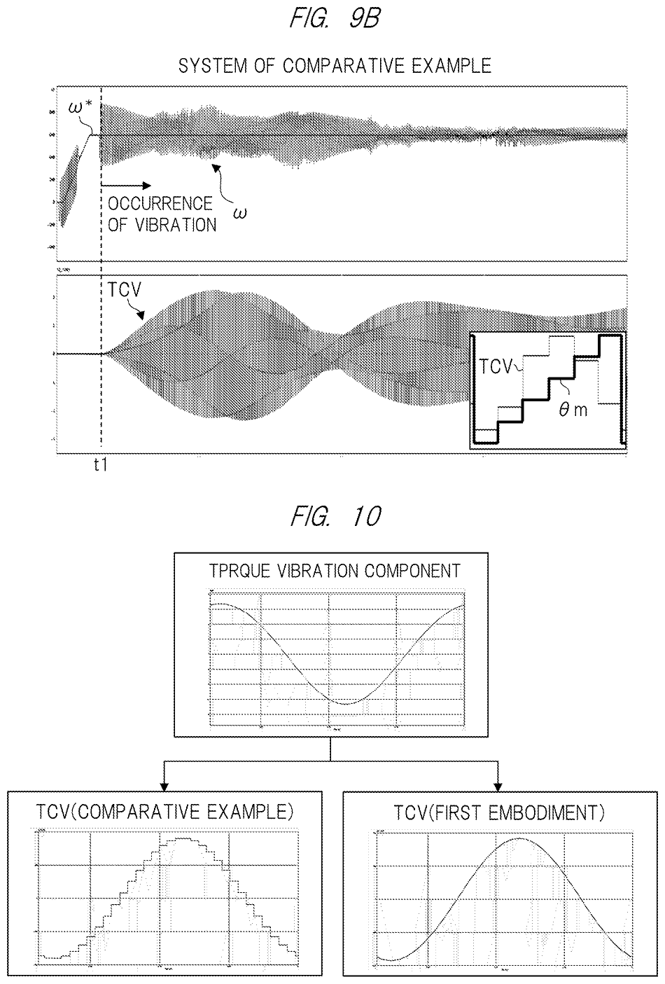

FIG. 10 is a schematic diagram for comparing the toque compensation values TCV between the used systems according to the comparative example and the first embodiment. In FIG. 10, the system according to the comparative example generates step-like values as the torque compensation values TCV for suppressing or canceling the torque vibration component. TO the contrary, the system according to the first embodiment can generate smooth values as the torque compensation values TCV.

### <Configuration of Vibration Component Extractor>

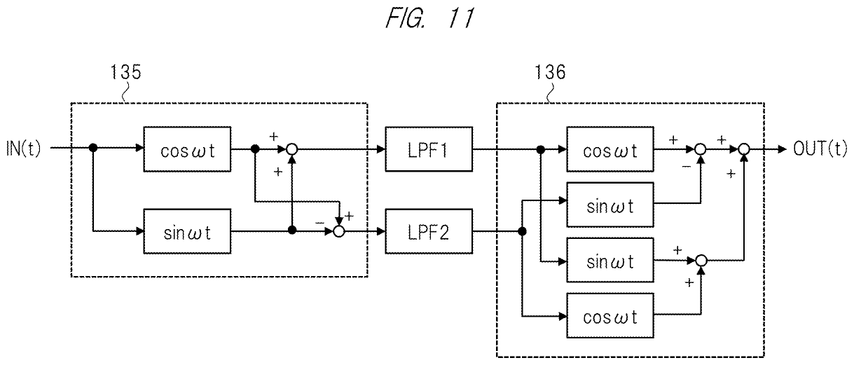

FIG. 11 is a block diagram illustrating an exemplary schematic configuration of main components in the vibration component extractor 121 of FIG. 4. In the example of FIG. 4, the vibration component extractor 121 is made of the Fourier transformer FT and the inverse Fourier transformer IFT. However, instead of this configuration, this may be made of a tracking filter as illustrated in FIG. 11. The tracking filter has a function to extract a specific frequency component, such as only a component synchronized with the rotation speed ω of the motor MT in this example, from an input signal IN(t), and to output the extracted signal as an output signal OUT(t).

The tracking filter of FIG. 11 includes, for example, a rotating-coordinate converter 135, lowpass filters LPF1 and LPF2, and a fixed-coordinate converter 136. The rotating-coordinate converter 135 converts the input signal IN(t) into a signal with rotating coordinates synchronized with the rotation speed ω. The lowpass filters LPF1 and LPF2 extract a direct-current component from the signal converted into the rotating coordinates, and removes a high-frequency component therefrom. The fixed-coordinate converter 136 returns the extracted direct-current component to a signal with fixed coordinates. Thereby, the output signal OUT(t) made of only the component synchronized with the rotation speed ω can be obtained.

The application of such a tracking filter to the vibration component extractor 121 of FIG. 2 can extract the torque vibration component having a speed synchronized with the rotation speed ω of the motor MT, and hence extract the cancel component for canceling the torque vibration component. In this case, the torque vibration component can be extracted by a simpler configuration than that in the case using the Fourier transformer FT and the inverse Fourier transformer IFT. Consequently, the processing load is reduced, and the time required for extracting the torque vibration component can be also reduced.

### Main Effects of First Embodiment

As described above, the system according to the first embodiment is provided with the compensation-value completion circuit 125a for calculating the torque compensation value TCV of any rotation angle θm of the motor MT by use of the compensation value table CTBL and the completion function. And, the polynomial based on the polynomial approximation is used for the completion function. Thereby, typically, the used memory capacity can be reduced while accurately suppressing the torque vibration. Specifically, even if the resolution of the discrete rotation angle θm is lowered, the sufficient vibration suppressive effect is obtained. Consequently, for example, even if a low-cost microcontroller with a small memory capacity or the like is used, the torque vibration can be accurately suppressed.

### Second Embodiment

### <Details of Torque Vibration Compensator>

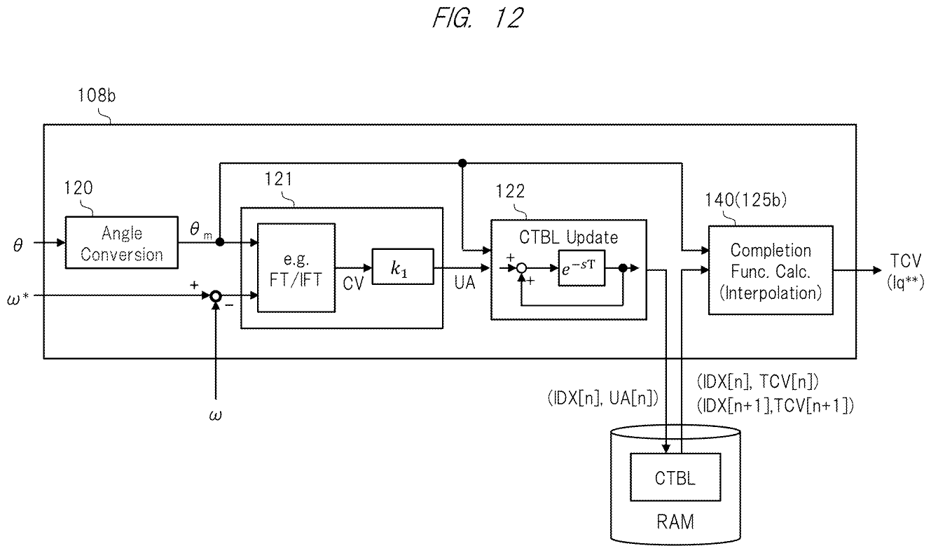

FIG. 12 is a block diagram illustrating an exemplary configuration of the torque vibration compensator 108 of FIG. 2 in a semiconductor device according to a second embodiment. A torque vibration compensator 108b of FIG. 12 is different from that of FIG. 4 in a configuration of a compensation-value completion circuit 125b. As similar to FIG. 4, the compensation-value completion circuit 125b calculates and derives the torque compensation value TCV of each any rotation angle θm of the motor MT by use of the compensation value table CTBL and the completion function. However, the compensation-value completion circuit 125b includes a completion-function calculation circuit 140 as different from FIG. 4.

The completion-function calculation circuit 140 calculates and derives the torque compensation value TCV by use of a preset primary interpolation function or secondary interpolation function as the completion function. That is, the completion-function calculation circuit 140 interpolates a torque compensation value TCV of a rotation angle θ between its adjacent discrete rotation angles θm by use of the torque compensation values TCV of the adjacent discrete rotation angles, based on the primary interpolation function or the secondary interpolation function. Thereby, the torque compensation value TCV of the rotation angle θ between the adjacent discrete rotation angles θm is an approximate value calculated and derived by the completion function.

More specifically, in use of the primary interpolation function, the completion-function calculation circuit 140 calculates and derives a torque compensation value TCV of a target rotation angle θm based on Equation (5). In use of the secondary interpolation function, the interpolation function calculation circuit 140 calculates and derives a torque compensation value TCV of a target rotation angle θm based on Equation (6).

$$\begin{matrix}[ Equation 5 ] & \\ U ( x ) = u ( {x}_{i} ) + \frac{u ( {x}_{i + 1} ) - u ( {x}_{i} )}{Δ x} ( x - {x}_{i} ) & ( 5 )\end{matrix}$$

$$\begin{matrix}[ Equation 6 ] & \\ U ( x ) = u ( {x}_{i} ) + \frac{u ( {x}_{i + 1} ) - u ( {x}_{i - 1} )}{2 Δ x} ( x - {x}_{i} ) + \frac{u ( {x}_{i + 1} ) - 2 u ( {x}_{i} ) + u ( {x}_{i - 1} )}{2 Δ {x}^{2}} {( x - {x}_{i} )}^{2} & ( 6 )\end{matrix}$$

In Equation (5) and Equation (6), a term u(xᵢ) indicates a torque compensation value TCV of “xᵢ” indicating a discrete rotation angle θm corresponding to the index IDX[i]. A term Δx indicates an angular difference [rad] between adjacent indexes IDX, that is, between adjacent discrete rotation angles θm as well as a resolution of the discrete rotation angle θm. A term (x−xᵢ) indicates a forward angle [rad] of “x” that is the target rotation angle θm relative to the “xᵢ.” Note that the value of the rotation angle θm is used as the variable “x” here. However, the value of the index IDX may be used as described in the first embodiment.

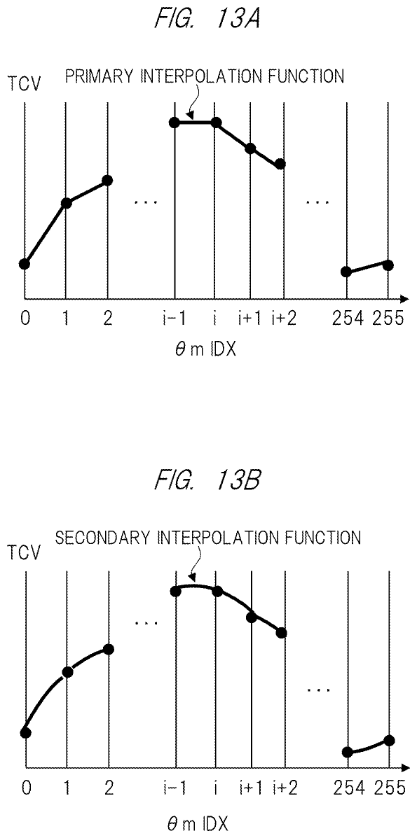

FIG. 13A is a diagram illustrating an exemplary torque compensation value TCV calculated and derived by use of the primary interpolation function in the completion-function calculation circuit 140 of FIG. 12. FIG. 13B is a diagram illustrating an exemplary torque compensation value TCV calculated and derived by use of the secondary interpolation function in the completion-function calculation circuit 140 of FIG. 12.

As illustrated in FIGS. 13A and 13B, the torque compensation value TCV of the rotation angle θm between its adjacent discrete rotation angles θm is interpolated based on Equation (5) or Equation (6). The torque compensation value TCV is more smoothly interpolated by use of the secondary interpolation function rather than use of the primary interpolation function. Generally, the torque vibration can be more accurately suppressed by use of a higher-order interpolation function. However, the use of the higher-order interpolation function makes a calculation volume larger.

### <Exemplary Specific Operations of Compensation-Value Completion Circuit>

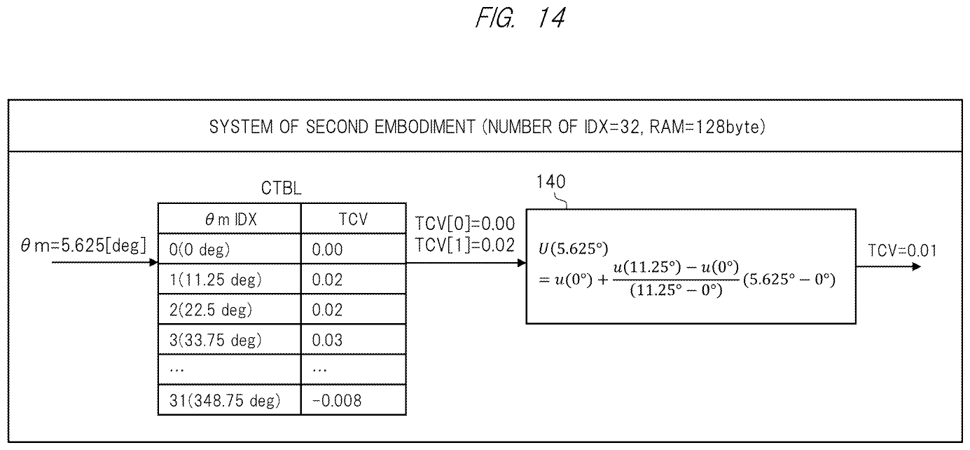

FIG. 14 is a schematic diagram illustrating exemplary specific operations of the compensation-value completion circuit 125b of FIG. 12. The compensation value table CTBL includes 32 indexes IDX in FIG. 14. Accordingly, the resolution of the discrete rotation angle θm is 11.25 [deg] (=360 [deg]/32). As similar to FIG. 19, when the torque compensation value TCV is expressed as a 4-byte digital value, the used memory capacity to be required is 128 bytes (=4 bytes×32).

In this example, the compensation-value completion circuit 125b that is the completion-function calculation circuit 140 receives, as its input, the rotation angle θm of 5.625 [deg] from the rotation angle converter 120. In this case, the completion-function calculation circuit 140 obtains the torque compensation values TCV[0] and TCV[1] of the indexes IDX[0] and IDX[1] corresponding to the discrete rotation angles θm of 0 [deg] and 11.25 [deg], respectively, from the compensation value table CTBL.

Then, in this example, the completion-function calculation circuit 140 operates the primary interpolation function of Equation (5) using u(0) (=0.00) and u(11.25) (=0.02) that are the obtained torque compensation values TCV[0] and TCV[1]. Consequently, the completion-function calculation circuit 140 calculates and derives “0.01” as the torque compensation value TCV of the rotation angle θm of 5.625 [deg]. More strictly, circuit 140 the completion-function calculation desirably performs the forward compensation as described in the first embodiment.

### <Verification Results>

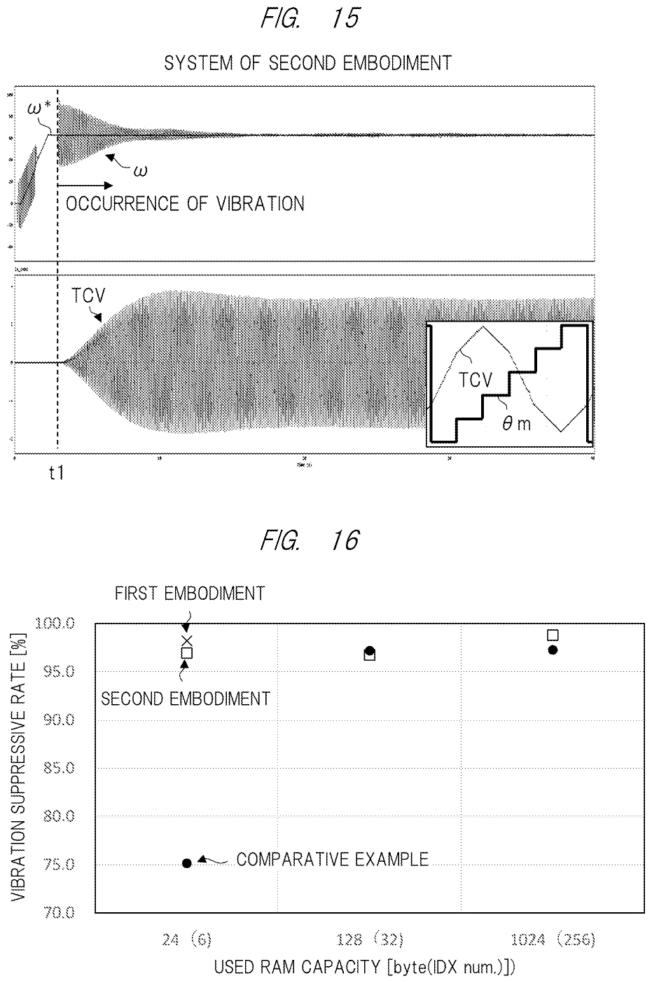

FIG. 15 is a diagram illustrating exemplary results of verifying the vibration suppressive effect in the application of the system according to the second embodiment of FIG. 12. As similar to FIGS. 9A and 9B, FIG. 15 illustrates time-series transitions of the speed command value ω*, the actual rotation speed ω of the motor MT, and the torque compensation value TCV. In this case, as similar to FIGS. 9A and 9B, the number of the indexes IDX of the compensation value table CTBL is six. That is, the used memory capacity is the same as those of FIGS. 9A and 9B. The used completion function is the primary interpolation function.

In FIG. 15, a torque vibration component due to disturbance, in other words, a vibration component synchronized with the rotation speed ω is applied at time t1, and its suppressive effect is verified. Consequently, a vibration suppressive effect of about 96.9% is obtained in comparison between magnitude of the vibration component obtained when the torque vibration suppression converges and a magnitude of the vibration component obtained at the same time in the case without the torque vibration suppression. That is, the used memory capacity can be further reduced while the torque vibration can be further accurately suppressed than in the system according to the comparative example of FIG. 9B. The amplitude of the torque compensation value TCV is almost constant. That is, the system provides the torque compensation value TCV that is neither excessively large nor excessively small but appropriate.

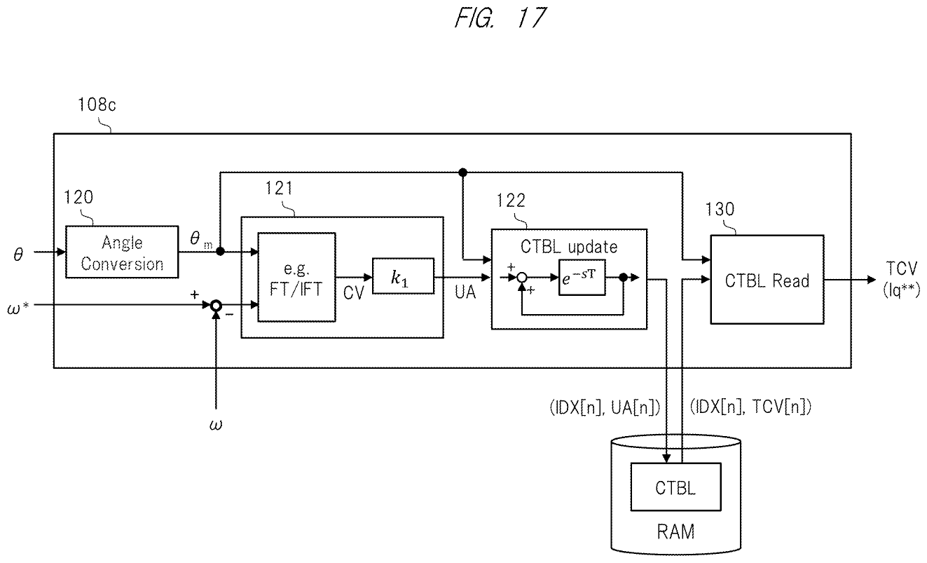

FIG. 16 is a diagram illustrating exemplary results of comparing and verifying the vibration suppressive effects for the used memory capacity in the systems according to the first embodiment, the second embodiment, and the comparative example. As illustrated in FIG. 16, the vibration suppressive effect using the system according to the second embodiment in which the compensation value table CTBL is of 1024 bytes is almost the same as the vibration suppressive effect using the first embodiment in which the compensation value table CTBL is of 24 bytes.

By the use of the system according to the first embodiment as described above, almost the same vibration suppressive effect can be achieved with the less used memory capacity than that in the system according to the second embodiment. However, the system according to the first embodiment needs a larger calculation volume for the polynomial approximation that is the simultaneous linear equation and the like than that in the system according to the second embodiment. That is, there is a risk of time taken for the calculation. Thus, the system according to the first embodiment or the system according to the second embodiment may be selected depending on, for example, the memory capacity, the processing performance, and the like of the semiconductor device 10.

### Main Effects of Second Embodiment

As described above, effects similar to the various effects of the first embodiment can be also obtained by the use of the system according to the second embodiment. That is, typically, the used memory capacity can be reduced while accurately suppressing the torque vibration. Further, although the used memory capacity may further increase than in the system according to the first embodiment, the processing load for calculating the torque compensation value TCV can be further reduced. Consequently, for example, even if a low-cost microcontroller with a low processing performance or the like is used, the torque vibration can be accurately suppressed.

In the foregoing, the invention made by the inventors of the present application has been concretely described on the basis of the embodiments. However, the present invention is not limited to the foregoing embodiments, and various modifications can be made within the scope of the present invention. For example, the above-described embodiments have been explained in detail for supporting the understandable explanation for the present invention, and are not always limited to the one including all structures explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

Typically, each component is mounted by a program processing using a central processing unit (CPU). That is, the CPU executes a program stored in a memory so that each component is mounted on the CPU. Each component may be mounted in not such software but hardware such as field programmable gate array (FPGA) or application specific integrated circuit (ASIC) or in a combination of software and hardware.

The above-described program can be stored in a non-transitory tangible computer readable medium, and can be provided to the computer. Examples of such a recording medium include a magnetic recording medium typified by hard disc drive, an optical recording medium typified by digital versatile disc (DVD) and Blu-ray disc, a semiconductor memory typified by flash memory and solid state drive (SSD) and others.

What is claimed is:

1. A semiconductor device configured to output a motor control signal to an inverter supplying a power to a motor and configured to control the motor via the inverter, the semiconductor device comprising:
a memory configured to store a program; and
a processor configured to execute the program stored in the memory,
wherein the memory further stores a compensation value table in which a compensation value of each of discrete rotation angles that are discrete rotation angles of the motor is registered, and
the processor is configured to, based on the program:
(a) extract a vibration component based on a speed difference between a preset speed command value and a value of a rotation speed of the motor, and calculate and derive an update amount of each of the discrete rotation angles required for suppressing the vibration component,
(b) update the compensation value table, based on the update amount of each of the discrete rotation angles, and
(c) calculate and derive the compensation value of each any rotation angle of the motor by use of the compensation value table and a completion function, and reflect the calculated and derived compensation value to the motor control signal.

2. The semiconductor device according to claim 1,
wherein the compensation value is an approximate value calculated and derived by use of the completion function.

3. The semiconductor device according to claim 1,
wherein the processor is configured to
generate, as the completion function, a polynomial indicating a relationship between the discrete rotation angle and the compensation value by performing polynomial approximation, when receiving, as its input, the compensation value of each of the discrete rotation angles registered in the compensation value table, and
calculate and derive the compensation value of each any rotation angle of the motor, based on the polynomial.

4. The semiconductor device according to claim 3,
wherein the processor is configured to perform the polynomial approximation for each time of the update of the compensation value table.

5. The semiconductor device according to claim 3,
wherein the discrete rotation angles in the compensation value table include 0 [deg] and 360 [deg], and
the processor is configured to
define the compensation value of the discrete rotation angle of 360 [deg] to be the same value as the compensation value of the discrete rotation angle of 0 [deg], and
perform the polynomial approximation on the compensation value table including the compensation values of the discrete rotation angles of 0 [deg] and 360 [deg].

6. The semiconductor device according to claim 1,
wherein the completion function is a primary interpolation function or a secondary interpolation function for interpolating the compensation value of a rotation angle between the discrete rotation angles that are adjacent, by use of the compensation values of the adjacent discrete rotation angles.

7. The semiconductor device according to claim 1, further comprising:
a pulse width modulation (PWM) signal generator provided behind the processor,
wherein the processor is configured to generate a duty-ratio command value depending on a magnitude of the compensation value, and
the PWM signal generator is configured to generate, as the motor control signal, a PWM signal based on the duty-ratio command value.

8. The semiconductor device according to claim 1,
wherein the processor is configured to update the compensation value table by integrating the update amount of each of the discrete rotation angles for each of the discrete rotation angles.

9. A semiconductor device configured to output a motor control signal to an inverter supplying a power to a motor and configured to control the motor via the inverter, the semiconductor device comprising:
a memory configured to store a compensation value table in which a compensation value of each of discrete rotation angles that are discrete rotation angles of the motor is registered; and
a motor controller configured to control the motor,
wherein the motor controller includes:
a vibration component extractor configured to extract a vibration component based on a speed difference between a preset speed command value and a value of a rotation speed of the motor, and to calculate and derive an update amount of each of the discrete rotation angles required for suppressing the vibration component;
a compensation-value table update circuit configured to update the compensation value table, based on the update amount of each of the discrete rotation angles; and
a compensation-value completion circuit configured to calculate and derive the compensation value of each any rotation angle of the motor by use of the compensation value table and a completion function, and to reflect the calculated and derived compensation value to the motor control signal.

10. The semiconductor device according to claim 9,
wherein the compensation-value completion circuit includes:
a completion-function generation circuit configured to generate, as the completion function, a polynomial indicating a relationship between the discrete rotation angle and the compensation value by performing polynomial approximation, when receiving, as its input, the compensation value of each of the discrete rotation angles registered in the compensation value table; and
a compensation-value calculation circuit configured to calculate and derive the compensation value of each any rotation angle of the motor, based on the polynomial.

11. The semiconductor device according to claim 9,
wherein the compensation-value completion circuit includes a completion-function calculation circuit configured to calculate and derive the compensation value of each any rotation angle of the motor, based on the preset completion function, and
the completion function is a primary interpolation function or a interpolation secondary function for interpolating the compensation value of a rotation angle between the rotation angles that are adjacent, by use of compensation values of the adjacent discrete rotation angles.

12. A motor control program configured to output a motor control signal to an inverter supplying a power to a motor and configured to control the motor via the inverter, the motor control program causing a computer to perform steps of:
(a) causing a memory to store a compensation value table defining a compensation value of each of discrete rotation angles that are discrete rotation angles of the motor;
(b) extracting a vibration component based on a speed difference between a preset speed command value and a value of a rotation speed of the motor, and calculating and deriving an update amount of each of the discrete rotation angles required for suppressing the vibration component;
(c) updating the compensation value table, based on the update amount of each of the discrete rotation angles; and
(d) calculating and deriving the compensation value of each any rotation angle of the motor by use of the compensation value table and a completion function, and reflecting the calculated and derived compensation value to the motor control signal.

13. The motor control program according to claim 12,
wherein the step (d) includes a step of generating, as the completion function, a polynomial indicating a relationship between the discrete rotation angle and the compensation value by performing polynomial approximation, when receiving, as its input, the compensation value of each of the discrete rotation angles registered in the compensation value table, and calculating and deriving the compensation value of each any rotation angle of the moto, based on the polynomial.

14. The motor control program according to claim 13,
wherein the discrete rotation angles in the compensation value table include 0 [deg] and 360 [deg], and
wherein the step (d) includes a step of defining the compensation value of the discrete rotation angle of 360 [deg] to be the same value as the compensation value of the discrete rotation angle of 0 [deg], and performing the polynomial approximation on the compensation value table including the compensation values of the discrete rotation angles of 0 [deg] and 360 [deg].

15. The motor control program according to claim 12,
wherein the completion function is a primary interpolation function or a secondary interpolation function for interpolating the compensation value of a rotation angle between the discrete rotation angles that are adjacent, by use of the compensation values of the adjacent discrete rotation angles.
